(19) United States
(12) Patent Application Publication
(10) Pub. No.: US 2020/0069114 A1
(43) Pub. Date: Mar. 5, 2020

(54) FITTING PART FOR BEING ATTACHED TO A COOKING OR FRYING VESSEL

(71) Applicant: Baumgarten handle systems KG, Neunkirchen (DE)

(72) Inventors: Michael Besche, Betzdorf (DE); Stefan Klaus, Wilnsdorf (DE)

(21) Appl. No.: 16/557,759

(22) Filed: Aug. 30, 2019

(30) Foreign Application Priority Data
Sep. 5, 2018 (DE) 102018121661.0

(51) Int. Cl. A47J 45/07; A47J 36/16; A47J 27/00

(52) U.S. Cl. CPC A47J 45/071; A47J 27/002; A47J 36/16

(57) ABSTRACT

A fitting part for attaching a handle element to the vessel wall of a cooking or frying vessel includes a base body having a recess for plugging onto a support part on the vessel wall, a securing element for securing the base body to the support part provided in the recess, and the securing element engaging at least one cast surface of the support part and/or at least one cast surface of the base body in a fixing manner, the securing element being at least one elastically deformable pressure spring having a wavelike profile, the opposite sides of the of the wavelike profile coming into contact with the support part on one side and with the inner side of the recess in the base body on the other side, and the pressure spring fixing the base body to the support part by friction-locking contact with at least one cast surface.

The disclosure of German Patent Application No. 10 2018 121 661.0 filed on Sep. 5, 2018, is incorporated herein by reference.

### TECHNICAL FIELD

The invention relates to a fitting part for being attached to a cooking or frying vessel.

### BACKGROUND

Generic fitting parts are attached to pots, casseroles or pans, for example, and serve to connect a handle or shaft handle to the vessel wall of a cooking or frying vessel. To enable separate production of the handle element and the actual cooking utensil because different materials are used, for example, the solutions known from the state of the art require the handle element to be attached to the finished vessel wall. Generic fitting parts are used to attach the handle element in this way.

In cooking utensils known from the state of the art, a support part onto which the fitting part is plugged by way of a recess in a base body in order to transmit retention forces is provided for attaching the handle element. To this end, an insertion opening is provided in the base body. To reliably preclude the handle element from being pulled off the connecting element, generic cooking utensils are provided with a securing element which is disposed with its side walls between the inner side of the attachment opening and the outer side of the connecting element. To be secured to the handle element, said securing element has barbed teeth which embed themselves into the handle element when the handle element is plugged onto the connecting element, thereby establishing a form and force-fitting connection.

A cooking utensil of this kind comprising a securing element for attaching the handle element on the support part is known from EP 0 228 560 B 1, for example. The disadvantage of the solution described there is that a secure fit of the securing element is ensured only if the recess in the base body and the cross-section of the support part are produced with high quality and in compliance with narrow production tolerances. Compliance with the required production tolerances is difficult in particular if the support part and/or the base body of the fitting part are supposed to be produced as castings. This is because castings exhibit relatively wide production tolerances due to the manner in which they are produced.

Hence, based on this state of the art, the object of the present invention is to propose a novel fitting part for attaching a handle element to a vessel wall of a cooking or frying vessel that allows the handle element to be securely attached even when using castings as the support part and as the base body.

### SUMMARY

The fitting part according to the invention is based on the idea that an elastically deformable pressure spring having a wavelike profile is used as a securing element for fixing the base body of the fitting part to the support part of the cooking or frying vessel. When the base body is attached to the support part, the two opposite sides of the wavelike profile of the pressure spring come into contact with the support part on one side and with the inner side of the recess on the other side. The base body is fixed to the support part by the two sides of the pressure spring coming into friction-locking contact with both the base body and the support part. The wavelike profile of the pressure spring allows relatively wide production tolerances to be easily compensated. The tolerances are compensated by the wave-profiled pressure spring being elastically deformed in a suitable manner.

To preclude twisting of the handle element relative to the vessel wall, it is particularly advantageous if the recess in the base body of the fitting part has a prismatic, in particular rectangular or quadratic, fixing cross-section. Once the support part on the vessel wall has been inserted into said prismatic recess of the base body, the base body can no longer be twisted relative to the vessel wall.

The constructive design of the securing element comprising the wave-profiled pressure spring is basically optional. With a view to a reliable fit of the base body on the support part by friction lock, it is particularly advantageous if the securing element has two pressure spring arms which can come into friction-locking contact with the opposite sides of the support part. By making the two pressure spring arms engage simultaneously, the friction force acting between the support part and the base body is doubled. Moreover, tolerance compensation can substantially be doubled, as well, because both wave-profiled pressure spring arms can be elastically deformed independently of each other for tolerance compensation.

To be able to mount the two pressure spring arms in the recess of the base body as easily as possible, it is particularly advantageous if the pressure spring arms are connected to each other via a connecting crosspiece, thereby forming a U-shaped spring clip. So, by mounting the U-shaped spring clip, two pressure spring arms can be easily positioned in the recess at the same time.

To further increase the fixing forces acting between the support part and the base body of the fitting part, two U-shaped spring clips together can form the securing element. The four pressure spring arms of the two spring clips come into friction-locking contact with the opposite sides of the support part, which means that the total of the acting friction forces corresponds to four times the fixing force acting on one pressure spring arm alone.

With a view to simple attachment of the spring clips to the base body, it is advantageous if the free ends of the spring clips are bent. In this way, the bent ends can be attached to the side of the base body that faces the vessel wall.

The spring clips are securely attached to the base body when the free ends of the spring clips are welded to the base body. To be able to reliably preclude the base body from being unintentionally pulled off the support part, it is advantageous if the spring clips additionally comprise a securing feature that at least slightly engages into the material of the support part and fixes the spring clips to the support part in a form-fitting manner. The way in which the securing feature is designed for form-fitting fixation of the base body to the support part is basically optional. According to a preferred embodiment, what is referred to as securing claws are integrated in the spring clips as the securing feature.

According to a preferred embodiment, the free ends of the securing claws should be embedded into the surface of the support part in a form-fitting manner when mounting the support part in the base body.

Preferably, the free ends of the securing claws point away from the insertion opening of the recess at a locking angle.

The type of handle element that is attached to the base body of the fitting part is basically optional. According to a preferred embodiment, the base body serves to attach a shaft handle to the vessel wall of the cooking or frying vessel.

According to the invention, high tolerance compensation can be achieved by the wavelike profile of the pressure springs used according to the invention. This is advantageous in particular if the base body or the support part is realized in the manner of a casting. It is particularly advantageous for both the base body and the support part to be realized in the manner of a casting because the dimensional tolerances occurring in the case of two castings are particularly wide.

The support part is particularly cost-effective to produce if it is molded in one piece with the vessel wall of the cooking or frying vessel.

### BRIEF DESCRIPTION OF DRAWINGS

An embodiment of the invention is schematically illustrated in the drawings and will be explained by way of example in the following description.

FIG. 1 shows a perspective cross-section of a fitting part according to the invention attached to the support part of a frying vessel;

FIG. 2 shows a cross-section of the fitting part with the frying vessel of FIG. 1;

FIG. 3 shows a perspective cross-section of the fitting part of FIG. 1;

FIG. 4 shows a cross-section of the fitting part of FIG. 3;

FIG. 5 is a front view of the fitting part of FIG. 3;

FIG. 6 is a top view of the spring clip for forming the fitting part of FIG. 3;

FIG. 7 is a side view of the spring clip of FIG. 6;

FIG. 8 is a front view of the spring clip of FIG. 6.

### DETAILED DESCRIPTION

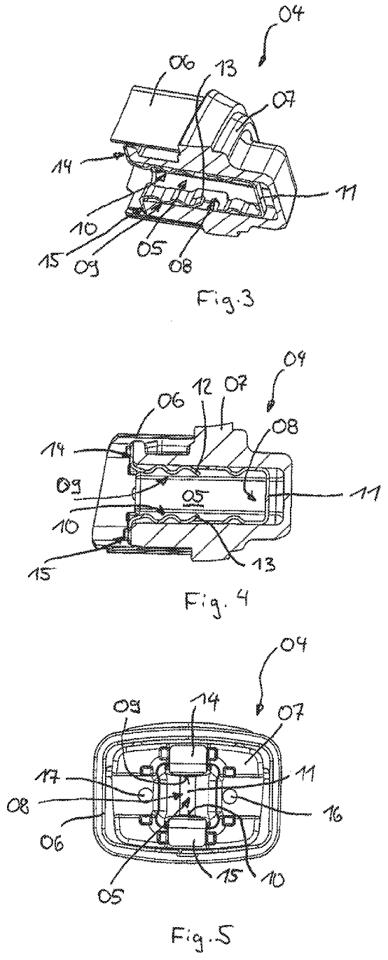

FIG. 1 shows a frying vessel 01 comprising a cast vessel wall 02 which is cast in one piece with a support part 03. A fitting part 04 which has a recess 05 (see FIG. 4) with which it is plugged onto the support part 03 serves to attach a shaft handle (not shown) to vessel wall 02. The space between the outer side of vessel wall 02 and fitting part 04 is covered by a sleeve 06 so as to enhance the optical aesthetics.

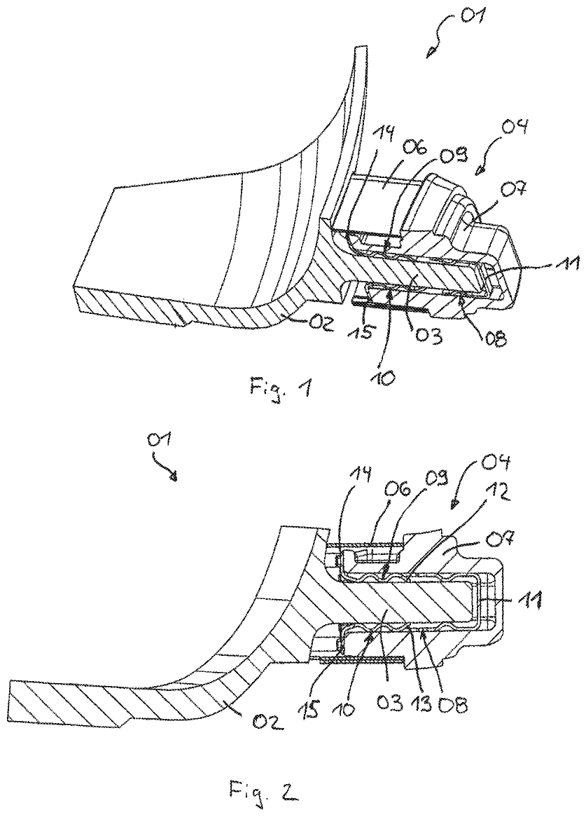

As can be seen from FIG. 2, in particular, base body 07 of fitting part 04 is fixed to support part 03 in a friction-locking and form-fitting manner by means of a spring clip 08. Support part 03 has a rectangular cross-section which is received in recess 05 in a manner complementary in shape, preventing fitting part 04 and thus the shaft handle attached thereto from being twisted relative to vessel wall 02. Since both support part 03 and base body 07 are castings, wide dimensional tolerances have to be compensated when attaching base body 07 to support part 03 in a form-fitting and friction-locking manner. This high dimensional compensation is achieved by using spring clip 08 because spring clip 08 has two pressure springs 09 and 10 which have a wavelike profile and are connected to each other via a connecting crosspiece 11, thereby forming the U-shape of spring clip 08. The wavelike profile of pressure springs 09 and 10 allows pressure springs 09 to elastically deform far enough when base body 07 is plugged onto support part 03 for the wave peaks to come into contact with the cast surfaces of base body 07 on one side and with support part 03 on the other side at relatively high contact pressure. Owing to the press-fit of pressure springs 09 and 10, a very strong friction lock is established between support part 03 and base body 07.

To additionally secure base body 07 against being pulled off support part 03, spring clip 08 additionally comprises two securing features 12 and 13 which become embedded in the material of support part 03 in a form-fitting manner when base body 07 is plugged onto support part 03. Securing features 12 and 13 are realized in the manner of securing claws whose free ends point away from the insertion opening of recess 05 at a locking angle. This locking angle has the effect that an attempt to pull base body 07 off support part 03 will cause the two securing features 12 and 13 to increasingly embed themselves in the material of support part 03, thus reliably precluding base body 07 from being pulled off.

FIG. 3 shows a perspective cross-section of fitting part 04. Securing feature 13 can be seen, which is produced by disengaging the spring clip body, which is made of steel sheet.

FIG. 4 shows a cross-section of fitting part 04. The clearance between the inward-facing wave peaks of pressure springs 09 and 10 on spring clip 08 is smaller than the outer diameter of support part 03, causing pressure springs 09 and 10 to be elastically deformed when base body 07 is plugged onto support part 03 and to establish the desired friction lock between support part 03 and base body 07.

FIG. 5 is a front view of spring clip 08 comprising the two pressure springs 09 and 10. Free ends 14 and 15 of the two pressure springs 09 and 10, respectively, are bent at right angles, allowing them to come into contact with the side of base body 07 that faces vessel wall 02. The two free ends 14 and 15 are welded to said side, thus securing the position of spring clip 08. To further increase the fixing forces between base body 07 and support part 03, a second spring clip 08 (not shown) may be additionally positioned in recess 05 in addition to said spring clip 08. Second spring clip 08 is fixed in recess 05 at 90° to first spring clip 08, which means that free ends 14 and 15 of the second spring clip (not shown) have to be welded to fixing points 16 and 17 of base body 07.

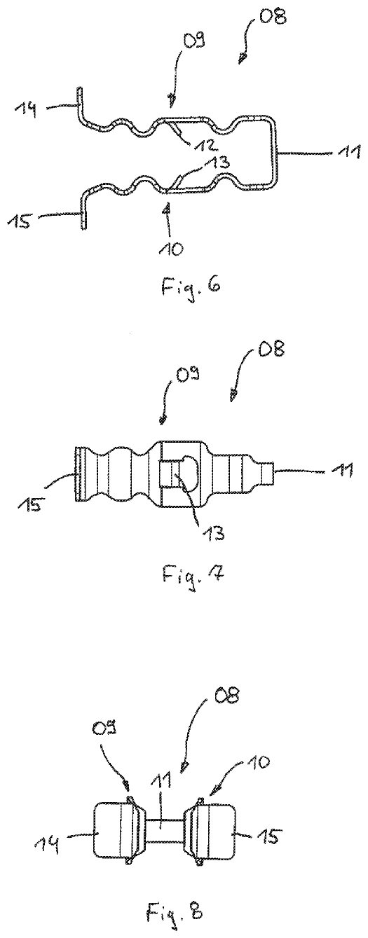

FIG. 6 is a top view of spring clip 08 comprising the two wave-profiled pressure springs 09 and 10, connecting crosspiece 11, securing features 12 and 13, and the two free ends 14 and 15 bent at right angles.

FIG. 7 is a side view of spring clip 08, and FIG. 8 is a front view of spring clip 08.

1. A fitting part (04) for attaching a handle element to the vessel wall (02) of a cooking or frying vessel (01), the fitting part (04) comprising a base body (07) which has a recess (05) with which it can be plugged onto a support part (03) provided on the vessel wall (02), a securing element by means of which the base body (07) can be secured to the support part (03) being provided in the recess (05) of the base body (07), and the securing element engaging at least one cast surface of the support part (03) and/or at least one cast surface of the base body (07) in a fixing manner, wherein the securing element comprises at least one elastically deformable pressure spring (09, 10) which has a wavelike profile, the opposite sides of the of the wavelike profile coming into contact with the support part (03) on one side and with the inner side of the recess (05) in the base body (07) on the other side, and the pressure spring (09, 10) fixing the base body (07) to the support part (03) by friction-locking contact with at least one cast surface.

2. The fitting part according to claim 1, wherein the recess (05) has a prismatic attachment cross-section.

3. The fitting part according to claim 1, wherein the securing element has two pressure springs (09, 10) which can come into friction-locking contact with opposite sides of the support part (03).

4. The fitting part according to claim 3, wherein the two pressure springs (09, 10) are connected to each other via a connecting crosspiece (11) and form a U-shaped spring clip (08).

5. The fitting part according to claim 4, wherein the securing element has two U-shaped spring clips (08), the four pressure spring arms (09, 10) of the spring clips (08) being configured to come into friction-locking contact with four opposite sides of the support part (03).

6. The fitting part according to claim 4, wherein the free ends (14, 15) of the spring clip (08) are bent and attached to the side of the base body (07) that faces the vessel wall (02).

7. The fitting part according to claim 6, wherein the free ends (14, 15) of the spring clip (08) are welded to the base body (07).

8. The fitting part according to claim 4, wherein the spring clip (08) comprises at least one securing feature (12, 13) which engages at least slightly into the material of the support part (03) and which fixes the spring clip (08) to the support part (03) in a form-fitting manner.

9. The fitting part according to claim 8, wherein the securing feature (12, 13) is realized in the manner of a securing claw.

10. The fitting part according to claim 9, wherein, when the support part (03) is mounted in the base body (07), the free end of the securing claw (12, 13) is embedded into the surface of the support part (03) in a form-fitting manner.

11. The fitting part according to claim 10, wherein the free end of the securing claw (12, 13) points away from the insertion opening of the recess (05) at a locking angle.

12. The fitting part according to claim 1, wherein the handle element is realized in the manner of a shaft handle which is attachable to the base body (07).

13. The fitting part according to claim 1, wherein the base body (07) is realized in the manner of a casting.

14. The fitting part according to claim 1, wherein the support part (03) is realized in the manner of a casting.

15. The fitting part according to claim 14, wherein the support part (03) is cast in one piece with the vessel wall (02).
